(19) United States
(12) Patent Application Publication
(10) Pub. No.: US 2009/0195951 A1
(43) Pub. Date: Aug. 6, 2009

(54) Method and Apparatus for Improved Electrostatic Discharge Protection

(76) Inventors: Bart Sorgeloos, Pittem (BE); Pieter Vanysacker, Pittem (BE)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 12/366,110

(22) Filed: Feb. 5, 2009

Related U.S. Application Data
(60) Provisional application No. 61/026,180, filed on Feb. 5, 2008.

(51) Int. Cl. H02H 9/04

(52) U.S. Cl. 361/56

(57) ABSTRACT

An ESD protection circuit having a triggering device, an ESD device and a circuit device coupled between the triggering device and the circuit device such that the circuit device conducts current only in one direction between the ESD device and the triggering device so the ESD device is in an active state for duration longer than time constant of the triggering device.

### CROSS REFERENCES

This patent application claims the benefit of U.S. Provisional Application Ser. No. 61/026,180 filed Feb. 5, 2008, the contents of which are incorporated by reference herein.

### FIELD OF THE INVENTION

The present invention generally relates to circuits that provide improved electrostatic discharge (ESD) protection, and more particularly to method and apparatus for providing improved ESD protection circuit with a good ESD performance having longer trigger duration with a reduced silicon area.

### BACKGROUND OF THE INVENTION

Integrated circuits (ICs) and other semiconductor devices are extremely sensitive to the high voltages that may be generated by contact with an ESD event, thus potentially causing damage to the IC. As such, electrostatic discharge (ESD) protection circuitry is essential for integrated circuits. An ESD event commonly results from the discharge of a high voltage potential (typically, several kilovolts) and leads to pulses of high current (several amperes) of a short duration (typically, 100 nanoseconds). An ESD event is generated within an IC, illustratively, by human contact with the leads of the IC or by electrically charged machinery being discharged in other leads of an IC. During installation of integrated circuits into products, these electrostatic discharges may destroy or impair the function of the ICs and thus require expensive repairs on the products, which could have been avoided by providing a mechanism for dissipation of the electrostatic discharge to which the IC may have been subjected. To simulate an ESD event during which the chip is grounded, three models are currently in use. Two of these models are Human Body Model (HBM) and Machine Model (MM), which are two pin tests (one pin grounded while another pin is positively or negatively stressed). When the IC itself is charged, discharge can happen through one pin. This type of stress is modeled as the Charged Device Model (CDM).

To protect an IC against ESD, specific protection circuits are added on chip. Referring to FIGS. 1a and 1b, there is illustrated conventional ESD protection circuit 100. One of the protection methods to protect a chip against ESD is to use a conventional protection clamp such as an NMOS 102 activated/triggered by a triggering device such as a transient detector 104. The detector 104 normally comprises a resistor R 106 and a capacitor C 108 coupled to the gate of the NMOS 102. Both the NMOS 102 and the transient detector 104 are coupled between two voltage nodes, node 1(ex: voltage supply) and node 2 (ex: ground). In order to improve the triggering of the protection circuits 100, an inverter 110 can be added as illustrated in FIG. 1b.

During operation of the ESD circuit 100, if the ESD stress is on node 1 versus node 2, the voltage will increase on this line and the capacitor C 108 will pull the gate of the NMOS 102 high, thus increasing the gate voltage of the NMOS 102. The NMOS 102 is now in a conductive mode and ESD current flows through it in order to be discharged. A time constant value is defined by the product of R and C (RC time constant). It is the time required to charge the capacitor, through the resistor, to 63.2 (≈63) percent of full charge; or to discharge it to 36.8 (≈37) percent of its initial voltage. These values are derived from the mathematical constant e, specifically 1/e. This time is defined at the moment where the voltage over the capacitor increases within 1/e of its final value. For voltage triggered circuits, this is the time that the output signal of the trigger circuit is also reached within 1/e of the value at the triggering point of the clamp . . . After the time constant, the gate voltage will decrease to the voltage of node 2 as the capacitor C 108 charges through the resistor R 106. The NMOS 102 is now in a non-conductive mode.

The approach described above applies only if the NMOS conducts only MOS current. The parasitic npn inherent in the NMOS can also conduct current. Applying a gate voltage to the NMOS will also help to turn on the parasitic npn. If this parasitic bipolar transistor is used, the RC time constant can be much smaller If the NMOS is used only in MOS mode, the time constant must be larger than the ESD pulse, i.e. in the order of microseconds. However, if the MOS is used in bipolar mode, the time constant can be much smaller, i.e. in the order of nanoseconds, for example 10 ns. This is because the bipolar mode is self sustaining. The drain of the MOS will avalanche and this avalanche current will keep the bipolar in an ON mode. This avalanche current is not present in MOS mode, so another stimulus is needed to keep on the MOS in MOS mode, which is the RC time constant. However, in bipolar mode, the RC time constant is no longer needed when the NMOS avalanche.

Additionally, by providing the inverter circuit 110 as illustrated in FIG. 1b, the output voltage of the inverter circuit 110 can be either low or high depending on the state of the NMOS 102. The advantage of using an inverter is to change the voltage level at the input of the NMOS 102.

FIG. 2 illustrates a graphical representation of the ESD pulse measurements of the ESD protection circuit 100 of prior art. As illustrated in FIG. 2, the NMOS 102 is conducting for a short time, i.e. about 34 ns and then after this time, the NMOS 102 is turned off.

The disadvantage of the technique described above is that the value of the time constant must be large in order for the NMOS to continue conducting for a longer period of time. This implies that the values of the R and the C must be large and so the silicon area consumed for the ESD protection is also large.

Thus, there is a need in the art to provide a protection technique for ESD protection that overcomes the disadvantages of the above discussed prior art that reduces the silicon area and still provides a good ESD performance.

### SUMMARY OF THE INVENTION

In one embodiment of the present invention provides an ESD protection circuit comprising a triggering device coupled between a first voltage potential and a second voltage potential. The ESD circuit also comprises an ESD device coupled between the first voltage potential and the second voltage potential such that the ESD device is coupled parallel to the triggering device. The ESD circuit further comprises a blocking device coupled between the triggering device and the ESD device, such that the blocking device conducts current only in a direction between the ESD device and the triggering device so the ESD device is in an active state for duration longer than time constant of the triggering device.

In a second embodiment of the present invention, the ESD protection circuit further comprising at least one inverter coupled between the triggering device and the blocking device.

In a third embodiment of the present invention, the ESD protection circuit further comprising a second triggering device coupled between the first and the second voltage.

In a fourth embodiment of the present invention, the ESD protection circuit further comprising at least one leakage device coupled to the blocking device and the ESD device.

### BRIEF DESCRIPTION OF THE DRAWINGS

The present invention will be more readily understood from the detailed description of exemplary embodiments presented below considered in conjunction with the attached drawings, of which:

FIG. 1 illustrates an ESD protection circuit in accordance with the prior art of the present invention.

FIG. 2 illustrates a graphical representation of the ESD response of the ESD protection circuit of FIG. 1 in accordance with the prior art of the present invention.

FIG. 3 illustrates a block diagram of an ESD protection circuit in accordance with one embodiment of the present invention.

FIG. 4 illustrates circuit elements of the block diagram of the ESD protection circuit of FIG. 3 in accordance with a preferred embodiment of the present invention.

FIG. 5 illustrates a graphical representation of the ESD response of the ESD protection circuit of FIG. 4.

FIG. 6 illustrates an ESD protection circuit in accordance with another embodiment of the present invention.

FIGS. 6a through 6f illustrate the ESD protection circuit of FIG. 6 in accordance with various alternate embodiments of the present invention.

FIG. 7 illustrates an ESD protection circuit in accordance with even another embodiment of the present invention.

FIG. 9 illustrates an ESD protection circuit in accordance with a further embodiment of the present invention.

FIGS. 10a through 10d illustrate the ESD protection circuit in accordance with additional embodiments of the present invention.

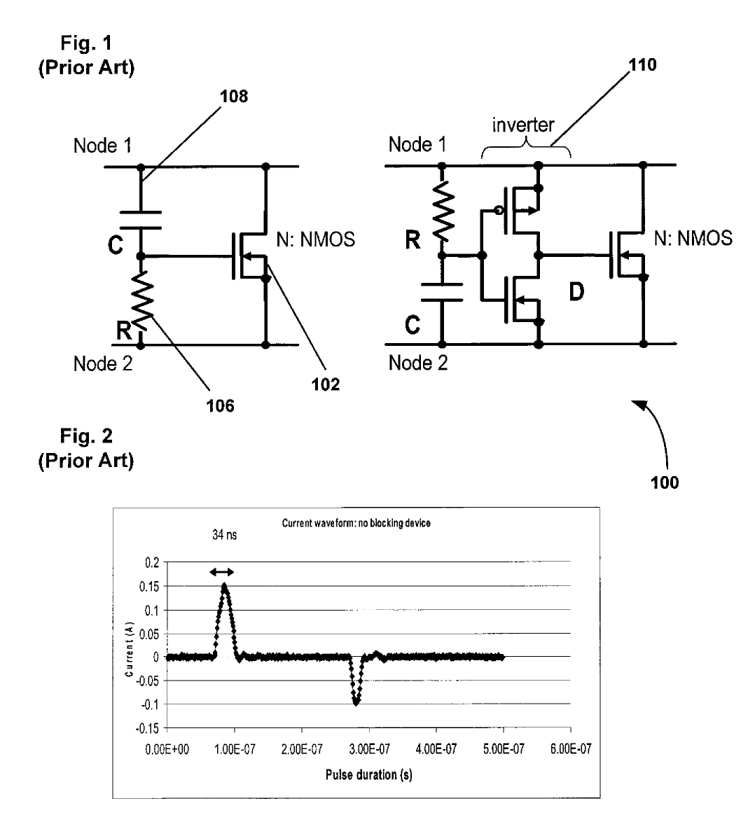

It is to be understood that the attached drawings are for purposes of illustrating the concepts of the invention.

### DETAILED DESCRIPTION OF THE INVENTION

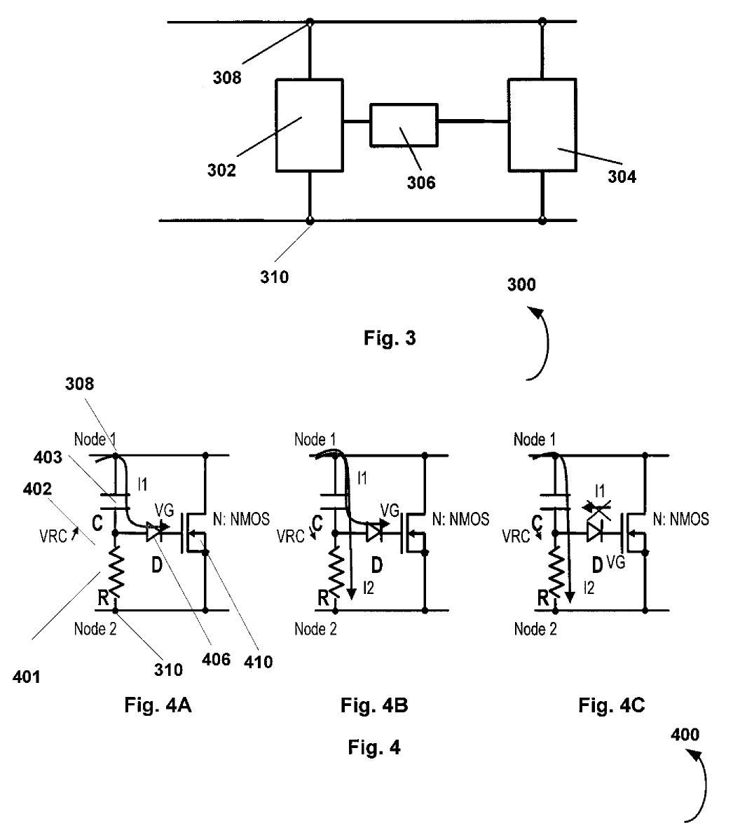

The present invention provides a solution to reduce the silicon area in the ESD protection device and still provide a good ESD performance. In one embodiment of the present invention, FIGS. 3 illustrates a block diagram of an ESD protection circuit 300 in accordance with an embodiment of the present invention. The circuit 300 includes a trigger device 302 and an ESD device 304 and a circuit device 306 coupled between the trigger device 302 and the ESD device 304. The circuit device 306 is also known as a blocking device 306 in the present invention since it is one directional, i.e. functions to conduct current only in one direction and blocks the current in the other direction. This blocking device 306 conducts current either towards or away from the ESD device 304 as will be described in greater detail below.

As shown in FIG. 3, one end of the trigger device 302 and the ESD device 304 is coupled to first voltage potential 308 and the other end of the trigger device 302 and the ESD device 304 is coupled to a second voltage potential 310. It is known to one skilled in the art that the first voltage potential 308 can be a voltage supply (Vdd) or ground or an input/output pad, or connected to any internal circuitry such as an inter-power domain interface. Similarly, the second voltage potential 310 can preferably be ground, or an input/output pad, or connected to any internal circuitry. However, for the purpose of the invention as described, the first voltage potential 308 is preferably connected to the voltage supply and the second voltage potential 310 is preferably connected to the ground.

Although not shown, the trigger device 302 may alternatively be coupled between different nodes from the ESD device 304. The ESD device 304 can preferably be an SCR, one or more MOS or one or more bipolar transistor. The trigger device 302 preferably includes an RC transient detector. The trigger device 302 may include a transient detector circuit combined with feedback techniques or inverter stages. One skilled in the art would appreciate that other devices, such as a MOS, diode, SCR, or even over-voltage/over-current sensing devices can be used as trigger devices.

The blocking device 306 in FIG. 3 can preferably include any of the elements including a diode, a MOS, a resistor, an inverter, a bipolar transistor, a capacitor, a silicon controller rectifier (SCR) etc. The blocking device may include any or combination of these elements as long as the current in the blocking device 306 flows in one direction between the ESD device 304 and the triggering device 302 in order to keep the ESD device 304 charged up for a time period longer than the time constant, the details of which are described in greater detail below.

In accordance with a preferred embodiment, FIG. 4 illustrates an ESD protection circuit 400 including circuit elements of the block diagram of the ESD circuit 300. The trigger device 302 preferably includes a RC transient detector 402 having a resistor R 401 and a capacitor C 403. The ESD device 304 preferably includes an NMOS 404 and the blocking device 306 preferably includes a diode 406 conducting current in only one-direction. FIGS. 4a, 4b and 4c show the current flow during the ESD event in the first, second and third stages, respectively.

Referring to FIG. 4a, during the initial stage of the ESD event, the voltage at the first voltage supply will increase and the capacitor C 403 will in turn increase the voltage (VRC) between the R 401 and the C 403. A current I1 will flow from the first voltage supply 308 through the diode 406 towards the NMOS 404, charging up the gate source capacitance of the NMOS 404. This results in an increase of the voltage at the gate, i.e. VG of the NMOS 404. Then, at a certain point, when enough voltage is build up, the NMOS 404 will turn ON (active) and the ESD current will now flow through the NMOS 404. This voltage is known as the threshold voltage of a NMOS ranging between ˜0.2V-1.2V depending on the technology. So, the current can easily flow from the first voltage supply 308 to the second voltage supply 310 through the channel of the NMOS 404

In a second stage as shown in FIG. 4b, the voltage VRC will begin to decrease due to the charging of the capacitance C 403 through the resistance R 401. This will cause a current I2 to flow from the first voltage supply 308 through the R 401 to the second voltage supply 310. As long as VRC is higher than VG, current, I1 will continue to flow towards the gate of the NMOS 404 through the diode 406.

In the final stage as shown in FIG. 4C, when the VRC is no longer higher than the VG, there will be no current flowing to the gate of the NMOS 404. This will cause the current I1 to flow in reverse from the gate of the NMOS 404 towards the diode 406. However the diode 406, conducting current in one-direction only, will block the current flow I1 in the reverse mode. So, the charges will remain on the gate of the NMOS 404. This will keep the gate voltage high, i.e. the NMOS 404 will remain in an active state even at a time much larger than defined by the RC time constant. In fact, the charges at the gate of the NMOS 404 will remain active even after the time period of the RC time constant-is over. So, by inserting the one-directional blocking device, such as the diode 406 between the trigger device and the ESD device, you need less time constant for the same duration for the gate voltage of the NMOS 402 to have a high value. Since the time constant is low, the values of the capacitor C 403 and the resistor R 401 will be small, thus taking less silicon area compared to the prior art. Again, note that the process described above will work very similar with devices other than a diode as the blocking device 306 and devices other than RC as trigger device 302.

Although not shown, the blocking device 306 can be alternatively placed so that current flows in one direction from the ESD device 304 in order to keep the ESD device 304 charged down for a time period longer than the time constant. For example (not limited to this example) this is the case if the ESD device 304 is a PMOS as will be described in greater detail below.

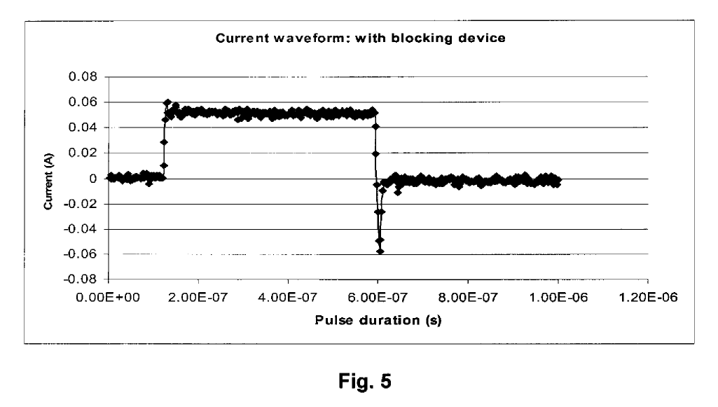

FIG. 5 illustrates a graphical representation of the ESD response measurements over the ESD device with a blocking device of the ESD protection circuit of FIG. 4. In FIG. 5, the ESD device is in conduction for about 500 ns thus indicating that the ESD device remains ON for a longer time with the blocking device. This ESD device remains ON for a period longer than the RC time constant, so it is not required to increase the values of the R and the C in the transient detector circuit, thus taking less silicon area compared to the prior art as discussed above.

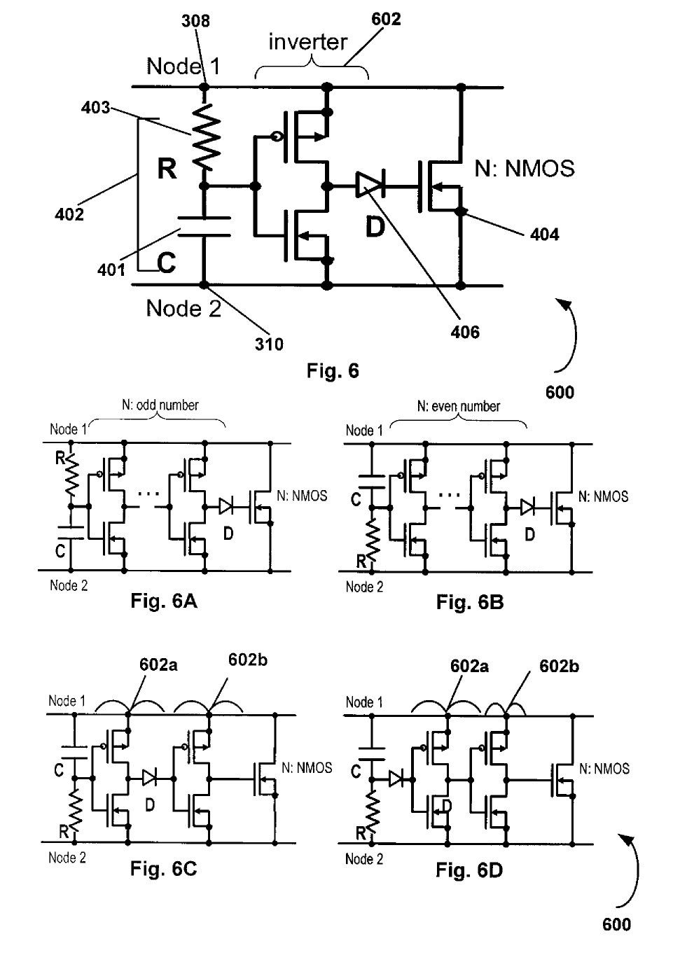

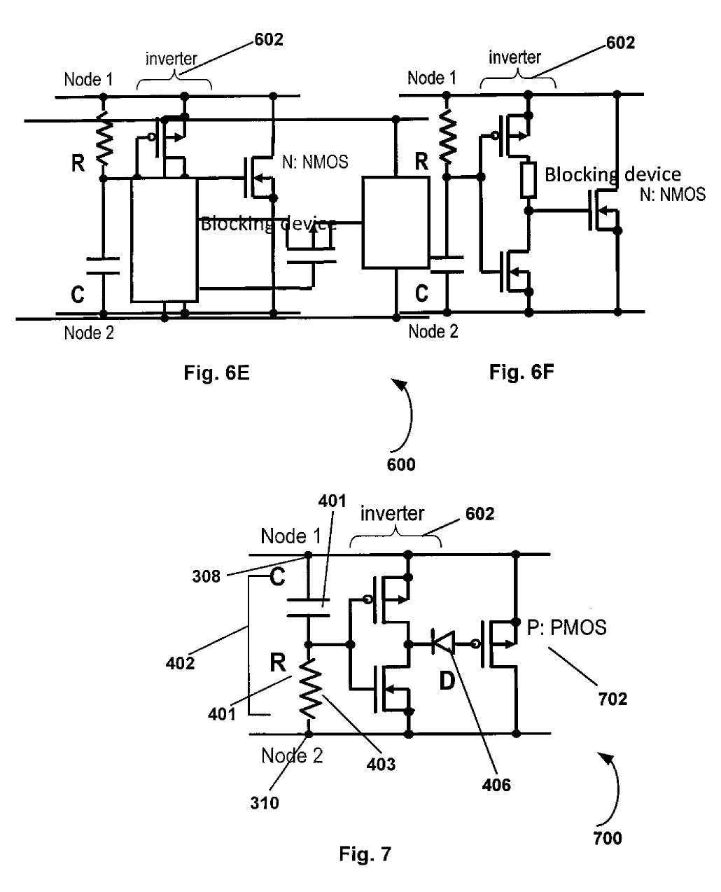

In another embodiment, an ESD protection circuit 600 includes an inverter 602 added to the circuit 400 as illustrated in FIG. 6 of the present invention. As shown, the inverter 602 is coupled between the transient detector 402 and the diode 406. Due to the presence of the inverter 602, the R 401 and the C 403 are switched such that the R 401 is now coupled to the first voltage supply 308 and the C 403 is coupled to the second voltage supply 310. One of the advantages of placing the inverter 602 is that the voltage before the diode 402 is pulled to a higher voltage of the second voltage supply 310 as long as the voltage VRC is higher than threshold voltage of the inverter 602. This threshold voltage is the minimum input voltage that is needed to switch the inverter 602 from a low output state to a high output state or vice versa. When an ESD pulse is between the first voltage supply 308 and the second voltage supply 310, initially the capacitor 401 will pull the voltage between the C 401 and the R 403 to ground. A low voltage input at the inverter 602 will set the output voltage high. When the output voltage of the inverter 602 is high, the blocking device 406, which in this example is the diode 406, will be charged up allowing current to flow to the gate to charge up the gate source capacitor. In a similar way, as described earlier, the NMOS 404 will turn on. The R 403 will charge up the C 401. Then, at a certain voltage, (i.e. the threshold voltage of the inverter 602) the inverter 602 will switch the output voltage from a high value to a low value. This also provides the blocking device 406 to prevent any current from flowing backward and the charges already present on the gate of NMOS 404 will remain on the gate, thus keeping the NMOS 404 ON for a longer period.

Even though FIG. 6 illustrates only one inverter, two or more inverters can be used as long as the VRC is higher than the threshold voltage as illustrated in FIGS. 6a and 6b. FIG. 6a illustrates the ESD protection circuit 600 of FIG. 6 with odd number of inverters 602 and FIG. 6b illustrates the ESD protection circuit 600 of FIG. 6 with even number of inverters 602. Also since FIG. 6b, comprises even number of inverters 602, the C 401 and the R 403 are switched. As discussed above, the RC is switched since initially a high voltage is needed at the gate of the NMOS 404, which means a high voltage is needed at the input of the blocking device 406. As known to one of ordinary skill, inverter 602 will transfer a high voltage to a low voltage and a low voltage to a high voltage. So, in the configuration with the odd number of inverters, the RC must pull the input of the inverter chain low i.e. C 401 coupled to the second voltage supply 310 and R 403 to the first voltage supply 308. Further in the configuration with the even number of inverters, the RC must pull the input of the inverter chain high i.e. Capacitor 401 to the first voltage supply 308.

FIGS. 6c through 6f illustrate some alternate embodiments of placing the diode 406 at different positions between the RC circuit 402 and the gate of the NMOS 404 with respect to the inverters 602. FIG. 6c shows the diode/blocking device 406 coupled between the inverters 602a and 602b. In this embodiment, the charges are placed at the inverter 602b, thus keeping this inverter 602b in the ON state. In FIG. 6c, not only the blocking device will block the charges on the gate of MOS 404 but also on one or more inverters 602. The RC circuit 402 will turn ON (active state) one or more inverters 602a and the blocking device 406 will charge also the one or more inverters 602b in the same state. However, when the voltage between the resistor 403 and capacitor 403 is discharged the blocking device 406 will also prevent the inverters 602a and 602b from changing their state, so the voltage at the input of the inverters 602 will be blocked. FIG. 6d shows the diode/blocking device 406 coupled between the RC transient detector 402 and the inverter 602a. In this embodiment, the input voltage of the inverter 602a will be high due to the current flowing from Node 1 308 to the diode 406. The output of the inverter 602a will be low and the input of the inverter 602b will also be low which 1 in turn will provide a high output, thus keeping the NMOS 404 in the ON state.

FIGS. 6e and 6f show the blocking device 306 device placed in the inverter 602 according to alternate embodiments of the present invention. By placing the blocking device 306 in the inverter 602, it prevents the inverter 602 from pulling the gate voltage of the NMOS 404 back to low value. In FIGS. 6e and 6f, in the initial stage, when the RC trigger circuit 402 is ON, the PMOS of the inverter 602 will pull the gate to a high voltage value. When the RC trigger circuit 402 is turning OFF, the PMOS of the inverter 601 is also turned OFF. Normally the NMOS of the inverter 602 will pull the gate back to ground, but the blocking device 306 will prevent that current flow from the gate of the NMOS 404 to the second voltage supply 310.

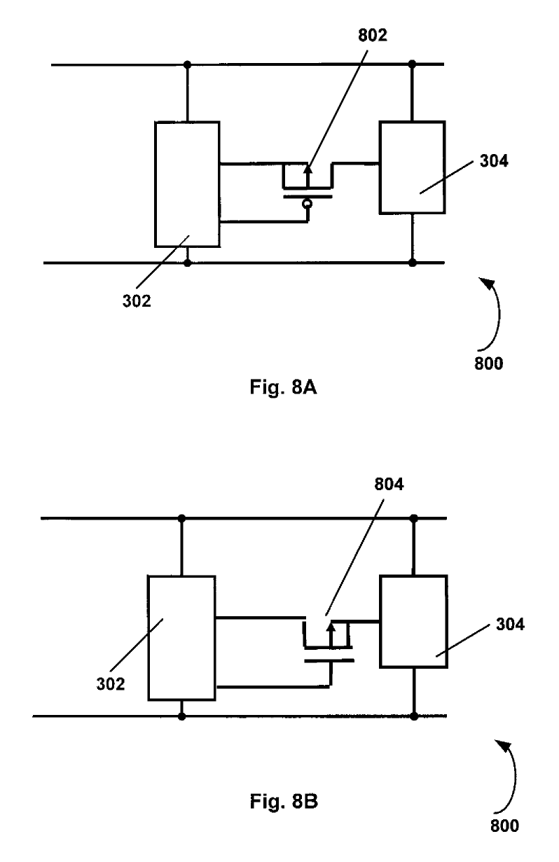

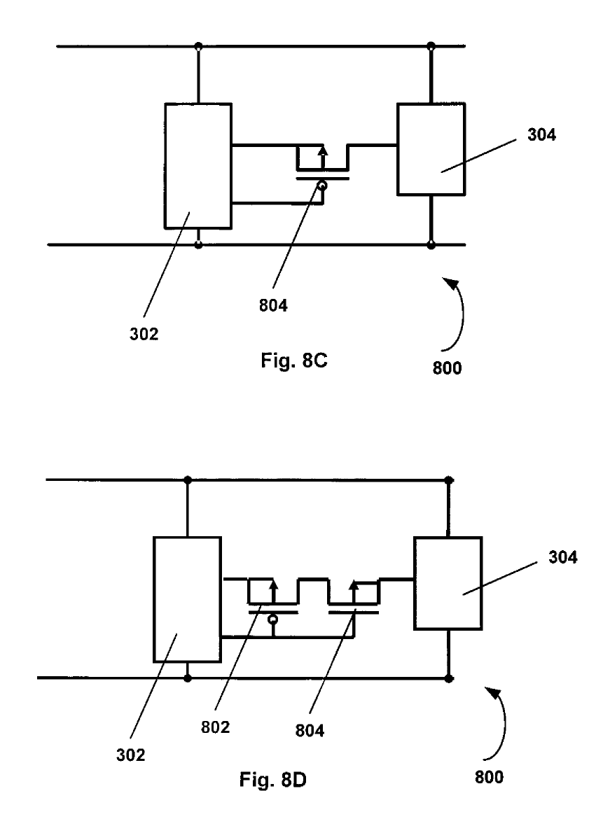

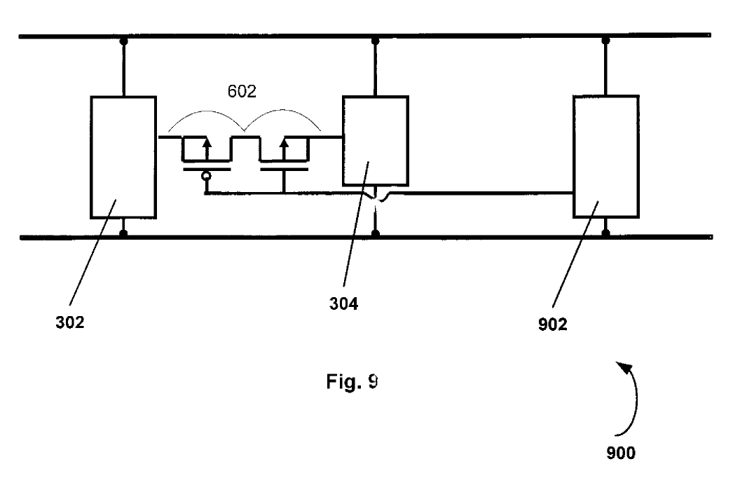

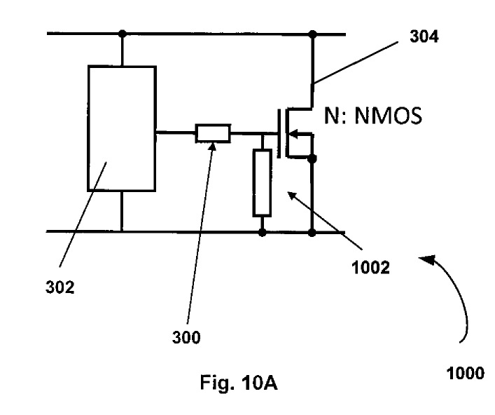

Referring to FIG. 7, there is illustrated an ESD protection circuit 700 in which a PMOS 702 is preferably the ESD device 304 which functions as the trigger switching circuit. The diode 406 functioning as a blocking device 306 is now in the reverse direction so the current flows from the PMOS 502 to the inverter 602. Also, the R 401 and the C 403 in the RC transient circuit 402 are switched. In order to turn a PMOS ON, the gate of the PMOS must be pulled below the source (threshold voltage). If an odd number of inverters are used the capacitor 401 must pull the input of this inverter 602 to a high voltage during an initial phase. The inverter 602 will transfer this to a low voltage at the blocking device 406, so that charges can be pulled away from the gate of the PMOS 702. This will pull the gate of the PMOS 702 to a voltage lower than the voltage at the source, turning the PMOS 702 in a conductive stage. When the voltage at the trigger circuit 404 decreases, the inverter 602 turns this into a high voltage, but the blocking device 406 will prevent the gate of the PMOS 702 from being pulled to a high voltage, thus keeping the PMOS 702 ON for a longer period

Referring now to FIGS. 8a through 8d, there is shown ESD protection circuits 800 depicting several embodiments of the different types of blocking devices 306 placed between the trigger device 302 and the ESD device 304. FIG. 8a illustrates a PMOS 802 as the blocking device 306. In this embodiment, when the voltage from the trigger device 302 to the ESD device 304 is forward biased, i.e. current will flow from tile ESD device 304 to the trigger device 302. This is due the low voltage of the gate compared to the drain of the PMOS 802. However, when the voltage is reverse biased, the PMOS 802 is turned off. (source and gate are both shorted and connected high). This will prevent the current to flow from the trigger device 302 to the ESD device 304. It is known to skilled in the art, that this implementation is not limited to PMOS as ESD device 304. When a NMOS is used as ESD device 304, the gate and bulk connection of PMOS 802 must be connected to the side of the ESD device 304. FIG. 8b illustrates an NMOS 804 as the blocking device 306 and functions similar to the PMOS 802 as described above. FIG. 8c illustrates NMOS 804 as the blocking device 306 with the gate connected to the source as shown. In this embodiment, when the voltage at the source is built Up during initial phase of the ESD pulse, then the voltage at the gate of the NMOS 804 will increase turning on the ESD device 304. However, when the voltage at the source decreases, then at a certain point, this voltage will become lower than the voltage at the ESD device 304 and the blocking device will be reverse biased. This will block any current from flowing anymore. FIG. 8d illustrates the blocking device 306 including combination of the NMOS 804 and the PMOS 802 coupled to each other. This combination of the NMOS 804 and the PMOS 802 function as an inverter such that during triggering the state of the inverter is changed. In other words, the trigger device 302 will change the input of the inverter, which will switch the output state of the inverter. So, during this transition, i.e. during the switching of the state of the inverter, current will flow from the trigger device 302 to the ESD device 304. After this switch or transition, the inverter will not conduct any more current and all the current will be blocked by either the PMOS 802 or the NMOS 804. So this combination of the NMOS 804 and the PMOS 802 as illustrated in FIG. 8d blocks the current from flowing back to the trigger device 302. It allows the current to flow only during a short period. Although not shown, the positions of the NMOS 804 and the PMOS 802 can preferably be reversed, yet will function in the same manner as discussed above.

Referring to FIG. 9, there is illustrated an ESD protection circuit 900 in accordance with a further embodiment of the present invention. In this embodiment, the circuit 900 comprise a second trigger device 902 also coupled to the blocking device 306 as shown. Even though, in this embodiment, the blocking device is an inverter 602, the blocking device may preferably be other elements such as a diode, a resistance, MOS etc. As shown in FIG. 9, the gate of the inverter 602 is coupled to the second trigger device 902. In this way, the time constant or trigger voltage of the trigger device 302 can be different from the time constant or trigger voltage of the inverter 602 coupled to the second trigger device 902. One of the advantages of this embodiment is that the inverter 602 can be controlled separately from the trigger device 302 For example less drive current is needed for this trigger circuit 902 than the first trigger device 302. The operation of the trigger device 302 is similar as previously described, but the conduction of the blocking device 304 will now also depend on the second trigger device 902. So, now in order for the blocking device 304 to conduct current, both the first and the second trigger circuit 302 and 902 respectively must provide an adequate current output. One example of the use of this embodiment (but not limited to) is that the blocking device 304 can be kept off during normal operation by the second trigger device 902.

As discussed above, the charges at the gate of the ESD device 302 remain at the gate and the current cannot flow in the reverse direction due to the blocking device 306. So, in theory, the MOS of the ESD device is always in the ON state, however, practically, there is always leakage current through the gate oxide of the MOS and through the blocking device 306 such that certain charges will leak away turning the MOS OFF. This process may take about 50-100 microseconds depending on the technology and implementation. So, there is a need to add a leakage device at the gate of the ESD device if it is desired to turn the clamp OFF more quickly. The leakage device provides a path with a low current that discharges the voltage at the gate of the ESD device within a certain time that is longer the ESD pulse.

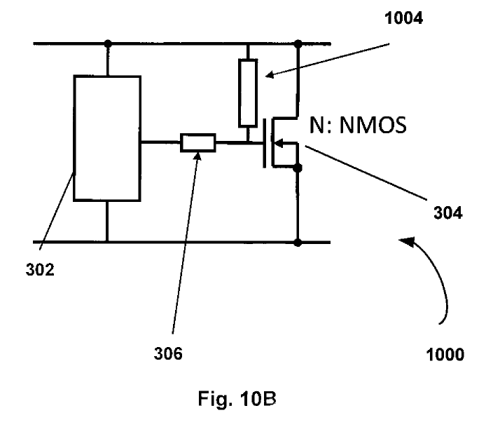

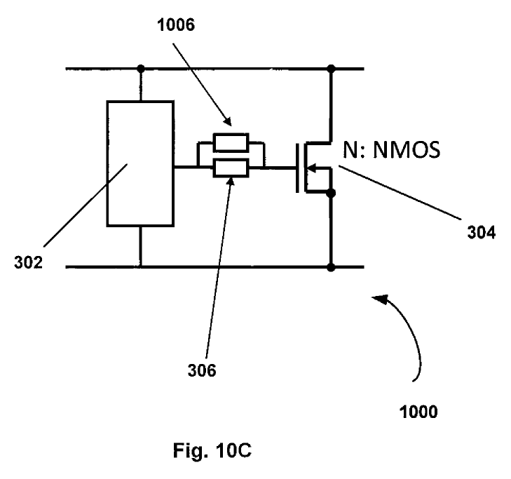

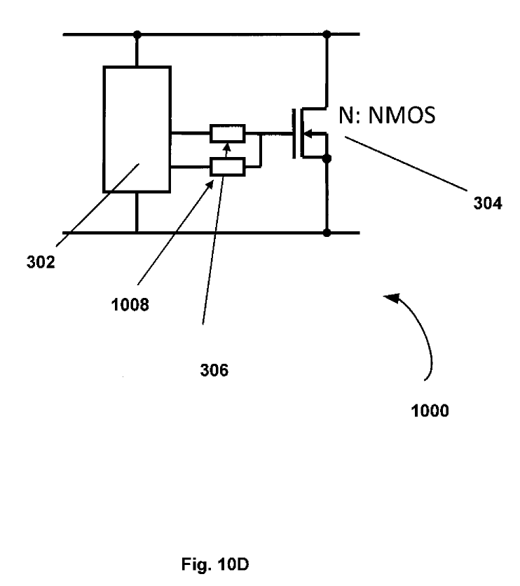

Referring to FIGS. 10a through 10d, there is shown several embodiments of the ESD protection circuit 1000 having the leakage device 802 at different locations of the circuit. FIG. 10a illustrates the leakage device 1002 coupled between the gate of the ESD device 304 and the second voltage supply 310. FIG. 10b illustrates the leakage device 1004 coupled between the gate of the ESD device 304 and the first voltage supply 308. FIG. 10c illustrates the leakage device 1006 coupled between the gate of the ESD device 304 and the blocking device 306 in such a way that any leakage current received from the ESD device 304 is an input to the blocking device 306. So, the leakage device 1006 provides a path for the leakage current to be fed back into the blocking device 306. FIG. 8d illustrates the leakage device 1008 coupled between the gate of the ESD device 304 and the trigger device 302 in such a way that any leakage current received from the ESD device 304 is an input to the trigger device 302. Even though each of the ESD protection circuits 1000 in FIGS. 10a through 10d illustrate only one leakage device, the invention is not limited to only one leakage device. The ESD protection circuits 1000 may have more than one leakage device as long as one of the nodes of the leakage device is coupled between the ESD device and the blocking device and the other node is connected either to ground, or VDD or the transient detection circuit in order to provide a path for the leakage current. Even though not shown, the leakage device may comprise one of a resistor, an inductor, a MOS with gate control, a diode, an inductor etc.

Although various embodiments that incorporate the teachings of the present invention have been shown and described in detail herein, those skilled in the art can readily devise many other varied embodiments that still incorporate these teachings without departing from the spirit and the scope of the invention.

1. An electrostatic discharge (ESD) protection circuit, comprising:
a triggering device coupled between a first voltage potential and a second voltage potential;
an ESD device coupled between said first voltage potential and said second voltage potential such that said ESD device is connected parallel to said triggering device; and
a circuit device coupled between the triggering device and the ESD device, wherein said circuit device conducts current only in one direction between the ESD device and the triggering device so that said ESD device is in an active state for a duration longer than a time constant of the triggering device.

2. The ESD protection circuit of claim 1 wherein said time constant is a time required for the triggering device to provide a trigger signal to the ESD device.

3. The ESD protection circuit of claim 1 wherein said triggering device comprises at least one of a RC transient detector, an inverter, a MOS, a diode, SCR, an over-voltage sensing device and an over-current sensing device.

4. The ESD protection circuit of claim 1 wherein said circuit device function to block the current in direction opposite the one direction between the ESD device and the triggering device.

5. The ESD protection circuit of claim 1 wherein said circuit device comprises at least one of a diode, a resistor, an inverter, a SCR, a MOS, a bipolar transistor and a capacitor.

6. The ESD protection circuit of claim 1 wherein said ESD device comprises at least one of a SCR, a bipolar transistor or a MOS.

7. The ESD protection circuit of claim 1 wherein said current flows only in a direction towards the ESD device when voltage of the triggering device is higher than the voltage at a gate of the ESD device.

8. The ESD protection circuit of claim 7 wherein said ESD device is an NMOS transistor.

9. The ESD protection circuit of claim 1 wherein said current flows only in a direction away from the ESD device when a voltage of the triggering device is lower than a voltage at a gate of the ESD device.

10. The ESD protection circuit of claim 9 wherein said ESD device is a PMOS transistor.

11. The ESD protection circuit of claim 1 further comprising at least one inverter coupled between said triggering device and said circuit device.

12. The ESD protection circuit of claim 1 further comprising at least one inverter coupled between said circuit device and said ESD device.

13. The ESD protection circuit of claim 1 further comprising at least one inverter coupled between said circuit device and said ESD device.

14. The ESD protection circuit of claim 1 further comprising at least one inverter, wherein the circuit device is placed in the inverter.

15. The ESD protection circuit of claim 1 wherein said triggering device triggers the circuit device to conduct current.

16. The ESD protection circuit of claim 1 further comprising a second triggering device is coupled between the first voltage potential and the second voltage potential.

17. The ESD protection circuit of claim 16 wherein said second triggering device coupled to said circuit device such that the second triggering device triggers the circuit device to conduct said current.

18. The ESD protection circuit of claim 16 wherein combination of said first and second triggering devices function to trigger the circuit device to conduct current.

19. The ESD protection circuit of claim 1 further comprising at least one leakage device, wherein one node of said leakage device is coupled between the circuit device and the ESD device and other node of said leakage device is coupled one of the first voltage potential or the second voltage potential, said leakage device function to provide a current path to discharge the ESD device

20. The ESD protection circuit of claim 1 wherein said leakage device comprises at least one of a resistor, a diode and a MOS.

21. The ESD protection circuit of claim 1 wherein said first voltage potential is a power supply and said second voltage potential is a ground.

22. The ESD protection circuit of claim 1 wherein said first voltage potential is ground and said second voltage potential is a power supply.

23. The ESD protection circuit of claim 1 wherein said time constant of the triggering device is in the range of 1 ns to 100 ns.

24. The ESD protection circuit of claim I wherein said duration of the active state of the ESD device is in the range of 100 ns to 1 us

25. An electrostatic discharge (ESD) protection circuit, comprising:
an ESD device coupled between a first voltage potential and a second voltage potential;
a triggering device coupled between a first voltage potential and a second voltage potential, said triggering device sends a trigger signal to the ESD device; and
a circuit device coupled between the ESD device and the triggering device such that said circuit functions to maintain the trigger signal at the ESD device after the trigger device has send the trigger signal.
